(19) United States
(12) Patent Application Publication
(10) Pub. No.: US 2026/0063485 A1
(43) Pub. Date: Mar. 5, 2026

(54) HANDLE MOUNTED TOOL WITH FORCE INDICATOR

(71) Applicant: CERTAINTEED GYPSUM, INC., Malvern, PA (US)

(72) Inventor: Matthew Edward KNUDTSON, Ann Arbor, MI (US)

(21) Appl. No.: 19/313,947

(22) Filed: Aug. 29, 2025

Related U.S. Application Data
(60) Provisional application No. 63/688,930, filed on Aug. 30, 2024.

(51) Int. Cl. G01L 5/00; B25G 1/04

(52) U.S. Cl. CPC G01L 5/0028; B25G 1/04

(57) ABSTRACT

A system and method for indicating a force applied to a tool is disclosed. The system can include a tool configured to engage a surface of a building; a handle configured to apply a first force to the tool, and a force indicator configured to indicate a representation of the first force to an operator. The method can include receiving a first force at a first tool, where a handle is configured to apply the first force to the first tool and cause the first tool to engage a surface of a building; and indicating, via a force indicator, a first indication to an operator when the first force is within a first predetermined range.

### CROSS-REFERENCE TO RELATED APPLICATION(S)

This application claims priority under 35 U.S.C. § 119 (c) to U.S. Provisional Patent Application No. 63/688,930, entitled “HANDLE MOUNTED TOOL WITH FORCE INDICATOR,” filed Aug. 30, 2024, by Matthew Edward KNUDTSON, which is assigned to the current assignee hereof and is incorporated herein by reference in its entirety.

### TECHNICAL FIELD

The present invention relates, in general, to handle mounted tools used in building construction.

### BACKGROUND

Handle mounted tools can be used in construction to apply paint to building surfaces, apply and finish joint compound for drywall joints, and sand surfaces to mention a few examples. When force is applied to the tool through the handle, the tool can engage a building surface with an engagement force, and perform an operation on the surface (e.g., sanding, painting, finishing, etc.) as the handle is manipulating the tool. It can be desirable for the engagement force to be within a predetermined range that is optimal for performing the particular operation. However, an operator using the handle to apply the engagement force to the surface generally has to get a “feel” for the operation before they can consistently perform the operation on the surface. However, sometimes even when the operator gets a “feel” for the operation, the operator can still perform it outside of the desired predetermined range of the engagement force, which can cause additional work and reduced efficiency in performing the operation. Therefore, improvements in handle mounted tools and their operation are continually needed.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for indicating a force applied to a tool. The system also includes a tool configured to engage a surface of a building; a handle configured to apply a first force to the tool, and a force indicator configured to indicate a representation of the first force to an operator. Other embodiments of this aspect include corresponding computer systems, apparatus, and computer programs recorded on one or more computer storage devices, each configured to perform the actions of the disclosed methods.

One general aspect includes a method for indicating a force applied to a tool. The method also includes receiving a first force at a first tool, where a handle is configured to apply the first force to the first tool and cause the first tool to engage a surface of a building; and indicating, via a force indicator, a first indication to an operator when the first force is within a first predetermined range. Other embodiments of this aspect include corresponding computer systems, apparatus, and computer programs recorded on one or more computer storage devices, each configured to perform the actions of the methods.

One general aspect includes the method. The selecting also includes selecting a second predetermined range; receiving a second force at the second tool, where the handle is configured to apply the second force to the second tool and cause the second tool to engage a second surface; and indicating, via the force indicator, a second indication to an operator when the second force is within the second predetermined range. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIGS. 1 and 2 are representative perspective views of a tool system with a force indicator being used by an operator to apply a corner molding to a corner of a drywall constructed wall, in accordance with certain embodiments;

FIG. 3 is a representative perspective view of a tool system with a force indicator that can provide an indication to an operator, with the indication representing an engagement force applied by the tool to a building surface, in accordance with certain embodiments;

FIG. 4 is a representative top view of a tool system with a force indicator system that can be wirelessly coupled to a remote control device and an identification device, in accordance with certain embodiments;

FIGS. 5A-5C are representative partial cross-sectional views of a tool system in various positions of a telescoping handle during engagement of the tool with a building surface, in accordance with certain embodiments; and

FIG. 6 is a functional block diagram of a force indicator system of the tool system, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

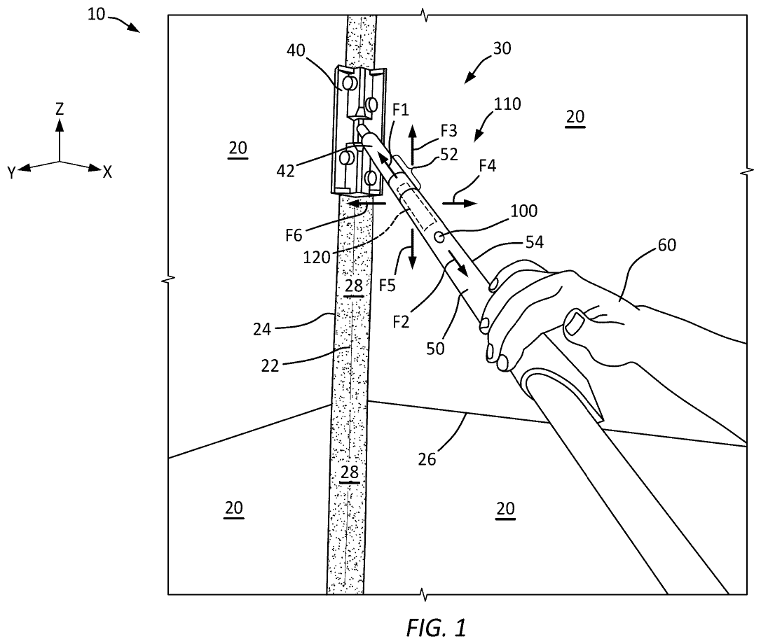

FIG. 1 is a representative perspective view of a tool system 30 with a force indicator 100, the tool system 30 being used by an operator 60 to apply a corner molding to a corner of a drywall constructed wall, in accordance with certain embodiments. It should be understood that this is a non-limiting example of how a tool system 30 can be used in performing an operation on a surface of a building 10. In this example, the tool system 30 can include a tool 40 removably attached to an end of a handle 50, with which an operator 60 can apply a force (e.g., any of the other forces F1-F6 or any combination of forces) to the tool 40. This allows the handle 50 to be used by the operator 60 to manipulate the tool 40 as needed to perform the operation on a surface (e.g., surface 28) of building 10.

In this example, a drywall wall has been constructed from multiple drywall panels 20, with gaps 26 between adjacent drywall panels 20. These gaps 26 are generally filled and covered by joint tape and joint compound to provide a smooth surface between the adjacent drywall panels 20. In a corner of the wall, the joint tape can be formed as a corner molding 22 and pressed into a bed of joint compound 24 at the corner in the wall where the adjacent drywall panels 20 meet. It can be desirable to run a tool 40 (e.g., a corner roller) along the corner to remove excess joint compound 24, properly embed the joint tape (e.g., corner molding 22 in this example), and provide as smooth of a finish as possible without removing too much joint compound 24 from the corner.

As can be seen, applying the proper engagement force to the corner molding 22 and the joint compound 24 by the tool 40 can be very important to reduce additional work required after the joint compound 24 is cured, such as reapplication of joint compound 24, sanding operations to further smooth the finished surface of the drywall wall before final operations such as painting. The current disclosure provides a handle 50 that can be removably attached to a tool 40 and as an operator is using the tool to engage a surface (e.g., surface 28) of the building 10, a force indicator system 110 that can indicate to the operator when the engagement force applied to the surface by the tool 40 is within a predetermined range of forces. The force indicator system 110 can also provide indications to the operator when the engagement force applied to the surface by the tool 40 is outside of the predetermined range of forces.

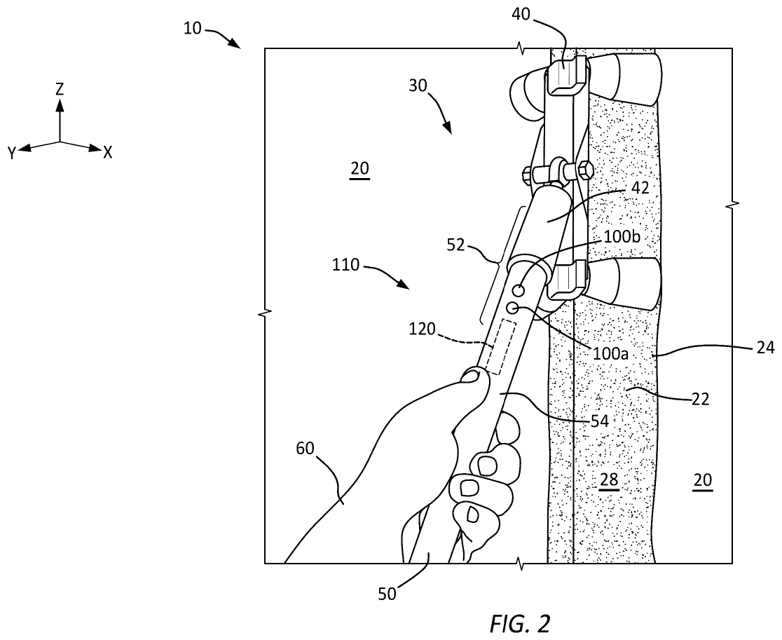

As used herein, the “predetermined range” of forces refers to the range of first forces F1 that can cause engagement forces to be applied by the tool 40 to the surface (e.g., surface 28) that produce an optimal performance of the tool 40. The predetermined range can vary for each type of tool 40. For example, the predetermined range of engagement forces for a tool 40 that floats a corner molding 22 as in FIG. 1, can be different (even though the difference can be small) than a tool 40 that floats a corner molding 22 as in FIG. 2 or a tool 40 that applies paint to a surface 28.

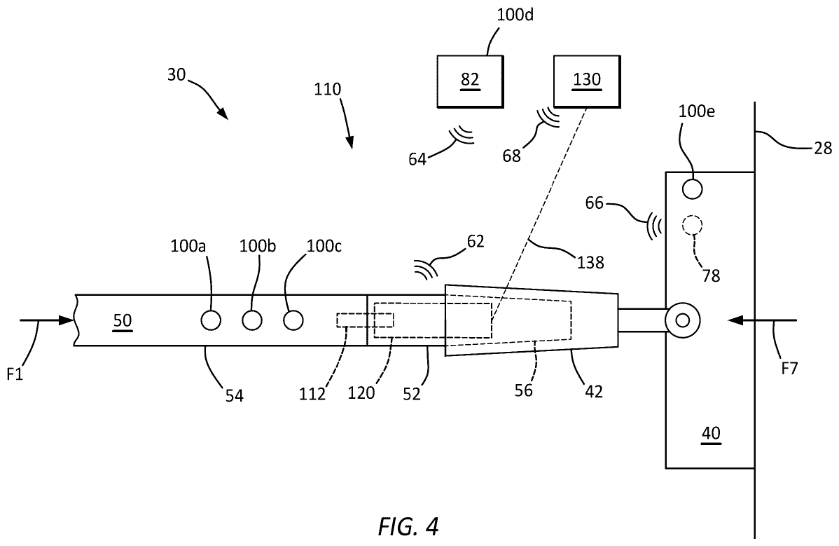

In general, the force F1 can contribute significantly more to application of the engagement force against the surface 28 than the other forces (F2-F6), except for maybe a second force F2, which directly opposes the force F1. The combined forces F1 and F2 can still be seen as a force F1, with both positive and negative values possible. Therefore, the force F1 can be used to determine the engagement force of the tool 40 to the surface 28. The force indicator system 110 can include a force transducer 112 (see FIG. 4) that can measure the force F1 being applied by the handle 50 to the tool 40.

A controller 120 of the force indicator system 110 can receive the measurements from the force transducer 112 and compare them to the predetermined range. If the measurements fall within the predetermined range, then the controller 120 can cause the force indicator(s) 100 to send an indication to the operator 60 that the force F1 is within the predetermined range. If the measurements fall outside of the predetermined range, then the controller 120 can indicate this by not generating an indication to the operator or the controller 120 can cause the force indicator(s) 100 to send an indication to the operator 60 that the force F1 is outside the predetermined range.

The controller 120 can also calculate an estimated engagement force between the tool 40 and the building surface based on the measurements of the forces F1-F6. In some embodiments, the forces F3-F6 may have negligible impact on the engagement force and the controller 120 can primarily use the force F1 to determine the engagement force. The controller 120 can compare the estimated engagement force with a predetermined range of forces, of the controller 120 can compare the measurements of the force F1 and compare those measurements with a predetermined range of forces associated with the force F1.

The indications can include one of a visual indication, an audio indication, a vibration indication, or a combination thereof. These indications can be used to indicate to the operator whether the force F1 is inside or outside the predetermined range. In a non-limiting embodiment, the visual indication, the audio indication, the vibration indication, or the combination thereof can be produced by a smartphone, a smartwatch, a tablet, a wearable device, or a mobile device that receives a signal from the controller to produce the first indication or other indications. These indications can be any of the indications described in this disclosure.

In a non-limiting embodiment, the visual indication, the audio indication, the vibration indication, or the combination thereof can be produced by a force indicator 100 disposed on or in the tool 40. These indications can be any of the indications described in this disclosure.

In a non-limiting embodiment, a visual indication can include one or more light sources that change in intensity to indicate that the force F1 is within the predetermined range. In a non-limiting embodiment, the one or more light sources can be variable intensity light sources that increase to a maximum intensity when the force F1 is within the predetermined range. In a non-limiting embodiment, the one or more light sources can increase intensity as a difference between the force F1 and the predetermined range is decreased and decrease intensity as a difference between the force F1 and the predetermined range is increased.

In a non-limiting embodiment, the visual indication can include one or more light sources that change in color or frequency to indicate that the force F1 is within the predetermined range. In a non-limiting embodiment, one or more light sources can be colored light sources that can display a second color when the force F1 is outside the predetermined range. In a non-limiting embodiment, one or more light sources can be colored light sources that display a first color when the force F1 is within the predetermined range, display a second color when the force F1 is below the predetermined range, and display a third color when the force F1 is above the predetermined range.

In a non-limiting embodiment, the one or more light sources can be variable frequency light sources that display a first frequency of light when the force F1 is within the predetermined range. In a non-limiting embodiment, the variable frequency light sources can emit a second frequency of light when the force F1 is below the predetermined range and emit a third frequency of light when the first force is above the predetermined range.

In a non-limiting embodiment, the one or more light sources include a first light source, a second light source, and a third light source, where the first light source emits a first color when the first force is within the predetermined range, the second light source emits a second color when the force F1 is below the predetermined range, and the third light source emits a third color when force F1 is above the predetermined range. The first color, the second color, and the third color can be the same color, different colors, or two being the same color and one being a different color.

In a non-limiting embodiment, the audio indication can include one or more audio sources that produce an audible signal that changes intensity of the audible signal to indicate that the force F1 is within the predetermined range. In a non-limiting embodiment, the one or more audio sources can be variable intensity audio sources that increase to a maximum intensity of the audible signal when the force F1 is within the predetermined range. In a non-limiting embodiment, the one or more audio sources can increase intensity of the audible signal as a difference between the force F1 and the predetermined range is decreased, and decrease intensity of the audible signal as a difference between the force F1 and the predetermined range is increased.

In a non-limiting embodiment, the audio indication can include one or more audio sources that produce an audible signal that changes frequency of the audible signal to indicate that the force F1 is within the predetermined range. In a non-limiting embodiment, the one or more audio sources can be variable frequency audio sources that increase to a maximum frequency of the audible signal when the force F1 is within the predetermined range. In a non-limiting embodiment, the one or more audio sources can increase frequency of the audible signal as a difference between the force F1 and the predetermined range is decreased, and decrease frequency of the audible signal as a difference between the force F1 and the predetermined range is increased. In a non-limiting embodiment, the one or more audio sources can decrease frequency of the audible signal as a difference between the force F1 and the predetermined range is decreased, and increase frequency of the audible signal as a difference between the force F1 and the predetermined range is increased.

In a non-limiting embodiment, the vibration indication can include one or more vibration sources that produce a vibration signal that changes intensity of the vibration signal to indicate that the force F1 is within the predetermined range. In a non-limiting embodiment, one or more vibration sources can be variable intensity vibration sources that increase to a maximum intensity of the vibration signal when the force F1 is within the predetermined range.

In a non-limiting embodiment, the one or more vibration sources can increase intensity of the vibration signal as a difference between the force F1 and the predetermined range is decreased and decrease intensity of the vibration signal as a difference between the force F1 and the predetermined range is increased.

It should be understood that various combinations of these indications can be used as desired to provide one or more indications to the operator 60 about the amount of engagement force that is being applied to the surface (e.g., surface 28) by the tool 40 in response to the application of the force F1 by the handle 50 to the tool 40.

The tool 40 can include a receptor 42 that can receive a threaded end 56 of the handle 50. In a non-limiting embodiment, the receptor 42 can be a body rotationally coupled to an applicator portion of the tool 40 with internal threads that receive external threads on the threaded end 56 of the handle 50. In a non-limiting embodiment, the receptor 42 can be a body rotationally coupled to an applicator portion of the tool 40 with external threads that receive internal threads of the threaded end 56 of the handle 50.

The handle 50 can include an operator portion 54 that can be used by the operator 60 to manipulate the handle 50 and a coupling portion 52 that can couple the operator portion 54 to the tool 40 (e.g., via the receptor 42). A force transducer 112 can be coupled between the operator portion 54 and the coupling portion 52 to measure axial forces (i.e., forces F1, F2 which can also be represented by the force F1) and bending forces (i.e., forces F3-F6) applied by the operator portion 54 to the coupling portion 52. Therefore, a gap between the operator portion 54 and the coupling portion 52 can be desirable to prevent interference of these portions with measurements of forces between these portions by the force transducer 112. Alternatively, or in addition to, the force transducer 112 can be configured to measure the axial forces (e.g., force F1) without much concern for the bending forces (e.g., forces F3-F6). In this configuration, the operator portion 54 can be slidingly coupled to the coupling portion 52 while being rotationally fixed with the coupling portion 52 and configured to minimize bending between these portions 52, 54.

For other tools 40 (e.g., a paint roller, a texture roller, a knife, a taping knife, a smoothing knife, a drywall knife, a utility knife, etc.), the bending forces F3-F6 can be more appropriate for gauging the proper engagement force of the tool 40 with the building surface. In this configuration, the gap between the operator portion 54 and the coupling portion 52 may be more appropriate. However, this disclosure provides for measuring and monitoring any of these forces F1-F6 to provide indications to an operator 60 to help the operator 60 provide a more consistent performance for the desired operation being performed by the tool 40.

The force transducer 112 can measure one or more of the forces F1-F6 and communicate the measurements to a controller 120, which can compare the measurements to one or more predetermined ranges. If the measurements fall within a desired predetermined range, the controller 120 can cause one or more indications to be generated by one or more force indicators 100 to alert the operator 60 that the correct engagement force is being applied by the handle 50. If the measurements fall outside the desired predetermined range, the controller 120 can cause one or more indications to be generated by one or more force indicators 100 to alert the operator 60 that the incorrect engagement force is being applied by the handle 50. This allows the operator 60 to have near immediate feedback about the engagement force and adjust a force being applied to the handle as needed to maintain the correct engagement force of the tool 40 with the building surface.

FIG. 2 is a representative perspective view of a tool system 30 with force indicators 100a, 100b, the tool system 30 being used by an operator 60 to apply a corner molding to a corner of a drywall constructed wall, in accordance with certain embodiments. It should be understood that this is a non-limiting example of how a tool system 30 can be used in performing an operation on a surface 28 of a building 10. In this example, the tool system 30 can include a tool 40 removably attached to an end of a handle 50, with which an operator 60 can apply a force (e.g., any of the other forces F1-F6 or any combination of forces) to the tool 40. This allows the handle 50 to be used by the operator 60 to manipulate the tool 40 as needed to perform the operation on a surface (e.g., surface 28) of building 10.

In this example, a drywall wall has been constructed from multiple drywall panels 20, forming a corner between adjacent drywall panels 20. On the corner of the wall, the joint tape can be formed as a corner molding 22 and pressed onto a bed of joint compound 24 at the corner of the wall where the adjacent drywall panels 20 meet. It can be desirable to run a tool 40 (e.g., a corner roller for outward corners) along the corner to remove excess joint compound 24, properly embed the joint tape (e.g., corner molding 22 in this example), provide as smooth of a finish as possible without removing too much joint compound 24 from the underneath the corner molding 22, and forming a crisp corner with the corner molding 22.

As in FIG. 1, the handle 50 can include an operator portion 54 that can be used by the operator 60 to manipulate the handle 50 and a coupling portion 52 that can couple the operator portion 54 to the tool 40 (e.g., via the receptor 42). A force transducer 112 can be coupled between the operator portion 54 and the coupling portion 52 and configured to measure axial forces and bending forces applied by the operator portion 54 to the coupling portion 52.

The force transducer 112 can measure one or more of the forces F1-F6 and communicate the measurements to a controller 120, which can compare the measurements to one or more predetermined ranges. If the measurements fall within a desired predetermined range, the controller 120 can cause one or more indications to be generated by one or more force indicators 100a, 100b to alert the operator 60 that the correct engagement force is being applied by the handle 50. If the measurements fall outside the desired predetermined range, the controller 120 can cause one or more indications to be generated by one or more force indicators 100a, 100b to alert the operator 60 that the incorrect engagement force is being applied by the handle 50. This can provide the operator 60 with near immediate feedback about the engagement force to adjust a force being applied to the handle as needed to maintain the correct engagement force of the tool 40 with the building surface.

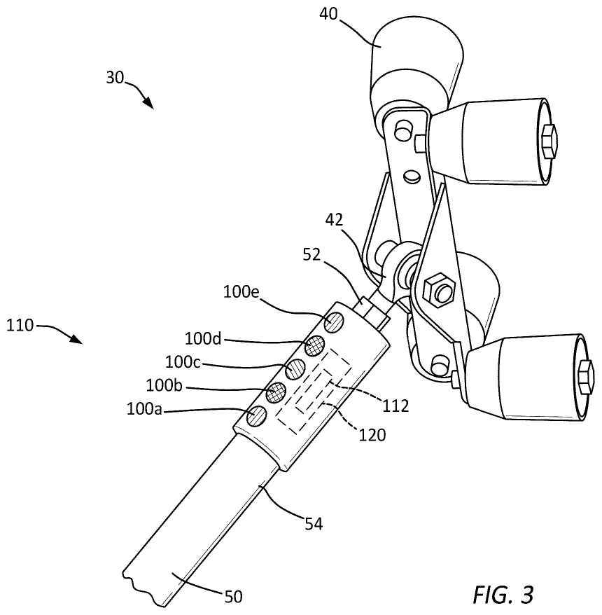

FIG. 3 is a representative perspective view of a tool system 30 with force indicators 100a-100c that can provide an indication to an operator 60, with the indication representing an engagement force applied by the tool 40 to a building surface (e.g., 28), in accordance with certain embodiments. It should be understood that this is a non-limiting example of how a tool system 30 can be used in performing an operation on a surface of a building 10. This tool system 30 is similar to the tool system 30 shown in FIG. 2, except that this embodiment has more force indicators 100a-100e than are shown in FIG. 2. Also, the receptor 42 includes external threads that can be mated to internal threads in the coupling portion 52 of the handle 50.

The force transducer 112 can measure one or more of the forces F1-F6 applied to the tool 40 via the handle 50 and communicate the measurements to a controller 120, which can compare the measurements to one or more predetermined ranges. If the measurements fall within a desired predetermined range, the controller 120 can cause one or more indications to be generated by one or more force indicators 100a-100e to alert the operator 60 that the correct engagement force is being applied by the handle 50. If the measurements fall outside the desired predetermined range, the controller 120 can cause one or more indications to be generated by one or more force indicators 100a-100e to alert the operator 60 that the incorrect engagement force is being applied by the handle 50.

The force indicators 100a-100e can be used to provide a visual sequence of indications which can provide an operator with immediate feedback as to if the engagement force is getting closer to the predetermined range, is within the predetermined range, or is getting farther away from the predetermined range. For example, the force indicators 100a-100e can each represent a range of forces, with a force indicator 100a being correlated to a first lower range of forces, a force indicator 100b being correlated to a second lower range of forces, a force indicator 100c being correlated to predetermined range of forces, a force indicator 100d being correlated to a first upper range of forces, and a force indicator 100e being correlated to a second higher range of forces.

In a non-limiting embodiment, as the engagement force is increased to a force within the first lower range of forces, the controller 120 can cause the force indicator 100a to generate a first indication to the operator 60. The force indicator 100a can illustrate to the operator 60 that the engagement force is too low for the desired operation. As the engagement force is increased to a force within the second lower range of forces, the controller 120 can cause the force indicator 100b to generate a second indication to the operator 60. The force indicator 100a can be deactivated or remain activated. The force indicator 100b can illustrate to the operator 60 that the engagement force is getting better but is still too low for the desired operation.

As the engagement force is increased to a force within the predetermined range of forces, the controller 120 can cause the force indicator 100c to generate a third indication to the operator 60. The force indicators 100a, 100b can be deactivated or remain activated. The force indicator 100c can illustrate to the operator 60 that the engagement force is within an optimal range for the desired operation.

If the engagement force is increased further to a force within the first upper range of forces, the controller 120 can cause the force indicator 100d to generate a fourth indication to the operator 60. The force indicators 100a, 100b, 100c can be deactivated or remain activated. The force indicator 100d can illustrate to the operator 60 that the engagement force is too high for the desired operation. If the engagement force is increased further to a force within the second upper range of forces, then the controller 120 can cause the force indicator 100e to generate a first indication to the operator 60. The force indicators 100a, 100b, 100c, 100d can be deactivated or remain activated. This can illustrate to the operator 60 that the engagement force is too high for the desired operation.

In a non-limiting embodiment, the force indicators 100a, 100e can be illuminated when the engagement force (or the force F1) is within an outer range of forces, the force indicators 100b, 100d can be illuminated when the engagement force (or the force F1) is within an inner range of forces, and the force indicator 100c can be illuminated when the engagement force (or the force F1) is within the predetermined range of forces. In this example, the outer range of forces can be outside the inner range of forces, and the inner range of forces can be outside the predetermined range. It should be understood that various other sequences of activating or deactivating the force indicators 100a-100e can be used to illustrate to the operator 60 when the engagement force is in an optimal range of forces or outside of the optimal range of forces.

FIG. 4 is a representative top view of a tool system 30 with a force indicator system 110 that can be wirelessly coupled to a remote control device 82 and an identification device 78, in accordance with certain embodiments. The force indicator system 110 can be used to indicate to the operator 60 when the force F1 (or the resultant engagement force F7) is within an optimal range of forces for preforming optimal performance of an operation by the tool 40 on the surface 28. The force transducer 112 can measure the force F1 and communicate the measurements to the controller 120. The controller 120 can compare the measured force F1 to a predetermined range of forces and determine if the force F1 is inside of or outside of the predetermined range.

The controller 120 can be positioned at various locations in the handle 50, such as bridging the interface between the operator portion 54 and the coupling portion 52, positioned within either the operator portion 54 or the coupling portion 52 (e.g., coupling portion 52 shown in FIG. 4). Even though it may not be preferred, the controller 120 can be positioned in the tool 40 and communicate wirelessly with the force indicators 100a-100d to produce the desired indications to the operator 60. Alternatively, or in addition to, the controller can communicate to the remote control device 82 or the force indicator 100e on the tool 40 via either wired or wireless communication.

In a non-limiting embodiment, the controller 120 can generate an indication to the operator 60 based on the comparison of the force F1 to the predetermined range. The indication can be a sequence of indications generated by the force indicators 100a-100c, or the controller 120 can wirelessly communicate with a remote control device 82 to produce an indication, or the controller 120 can wirelessly communicate with a force indicator 100e in or on the tool 40 to cause an indication to be provided to the operator 60.

In a non-limiting embodiment, the controller 120 can communicate with the remote control device 82 to produce any one of a visual indication, an audio indication, a vibration indication, or a combination thereof. The remote control device 82 can be any one of a smartphone, a smartwatch, a tablet, a wearable device, or a mobile device that receives a signal from the controller to produce one or more indications. The indication can also be a visual indication of a chart, icon, or other visual pattern that can be animated to indicate the level of the force F1 as the force F1 varies, and the indication can highlight, through the chart, icon, or visual pattern when the force F1 is inside or outside the predetermined range.

In a non-limiting embodiment, the controller 120 can communicate with the force indicator 100e to produce any one of a visual indication, an audio indication, a vibration indication, or a combination thereof.

The tool system 30 can be configured such that any one of multiple tools 40 can be used and each of the multiple tools 40 can be interchangeable with the other ones of the multiple tools 40. However, each of the tools 40 can perform optimally through a different range of forces for force F1. Therefore, a first tool 40 may perform optimally when a first predetermined range of forces is applied to the first tool 40 via the handle 50, but a second tool 40 may perform optimally when a second predetermined range of forces is applied to the second tool 40 via the handle 50, and furthermore a third tool 40 may perform optimally when a third predetermined range of forces is applied to the third tool 40 via the handle 50. It should be understood that the first, second, and third predetermined ranges can include different forces than the others, but they can also include some of the same forces as the others. Therefore, first, second, and third predetermined ranges can have forces that overlap with each other, but they can also contain forces that are not included in the others.

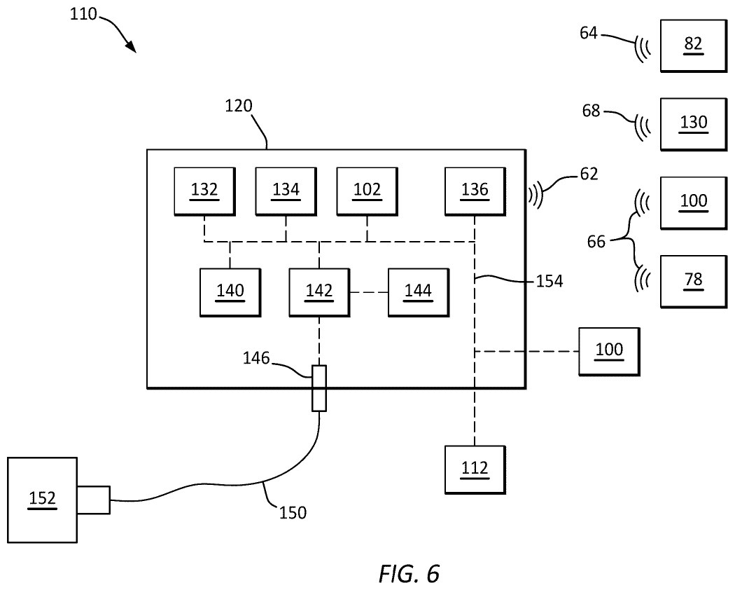

The tool system 30 can provide a means to select the appropriate predetermined range of forces (and any other outside ranges) for a particular tool 40. Therefore, when a first tool 40 is removably attached to the handle 50, the tool system 30 can communicate to the controller 120 the type of the first tool 40 and the controller 120 can retrieve the appropriate predetermined range of forces (and any other outside ranges) for a particular tool 40 from a database (e.g., force database 140 in FIG. 6). When a first tool 40 is removed and a second tool 40 is removably attached to the handle 50, the tool system 30 can communicate to the controller 120 the type of the second tool 40 and the controller 120 can retrieve the appropriate predetermined range of forces (and any other outside ranges) for a particular tool 40 from a database. This allows the tool system 30 to be easily adapted to various types of tools 40 and tailor the force indicators 100 as needed to provide indications appropriate for the tool 40 being used.

The controller 120 can include a force selector 102 (see FIG. 6) that receives the tool type and configures the controller 120 to control the force indicators 100 (e.g., force indicators 100a-100c) to provide appropriate indications based on the ranges of the force F1 being applied to the tool 40. The tool type can be determined by scanning, via the controller 120, an identification device 78 that can be coupled to each one the multiple tools 40. The identification device 78 can be a device that supplies a tool type of the attached tool 40 to the controller 120 and the force selector 102 can retrieve the appropriate force ranges from the database to configure the controller 120 for the attached tool 40.

Alternatively, or in addition to, the force selector 102 can receive the tool type from a remote control device 82 that can communicate the tool type to the controller 120 (via either wired or wireless communication). The remote control device 82 can scan the identification device 78 to retrieve the tool type or the operator can enter the tool type to the remote control device 82, which can then send it to the controller 120. The remote control device 82 can also recognize the tool type based on imagery from a camera and supply the tool type to the controller 120.

Alternatively, or in addition to, the force selector 102 can receive the tool type from a human machine interface (HMI) device 130. The HMI device 130 can be coupled to the controller 120 via a communication link 138, and the operator 60 can use the HMI device 130 to communicate the tool type to the controller 120. The HMI device 130 can be installed on the handle 50 or remote from the handle 50. The HMI device 130 can be any one of a button, a switch, a rotary selector, a voice recognition module, a touch screen, a smartphone, a smartwatch, a wearable device, a tablet, a mobile device, a keyboard, a mouse, a keypad, a joystick, a trackball, or a combination thereof. The HMI device 130 and the remote control device 82 can be different devices or the same device performing both functions.

The communication link 138 can be either a wired or wireless communication link. Preferably, if the HMI device 130 is disposed on the handle, then a wired communication link can be more appropriate, and if the HMI device 130 is remote from the handle, then a wireless communication link can be more appropriate.

The force selector 102 can also configure the controller 120 to use a subset of the available force indicators 100a-100e for a particular type of tool 40.

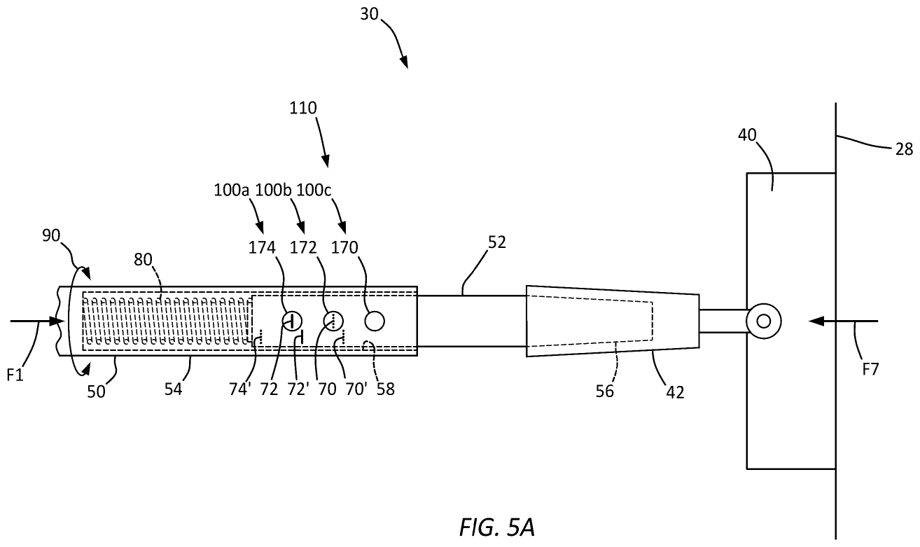

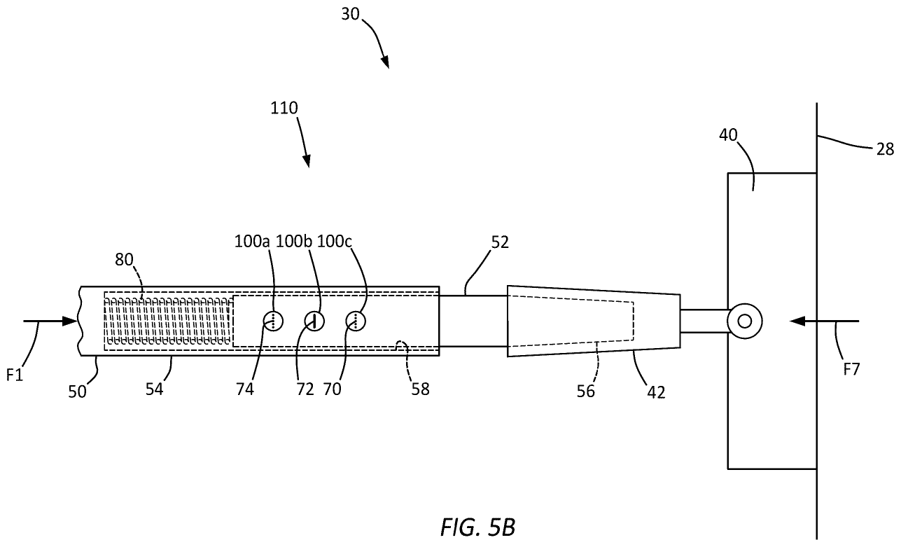

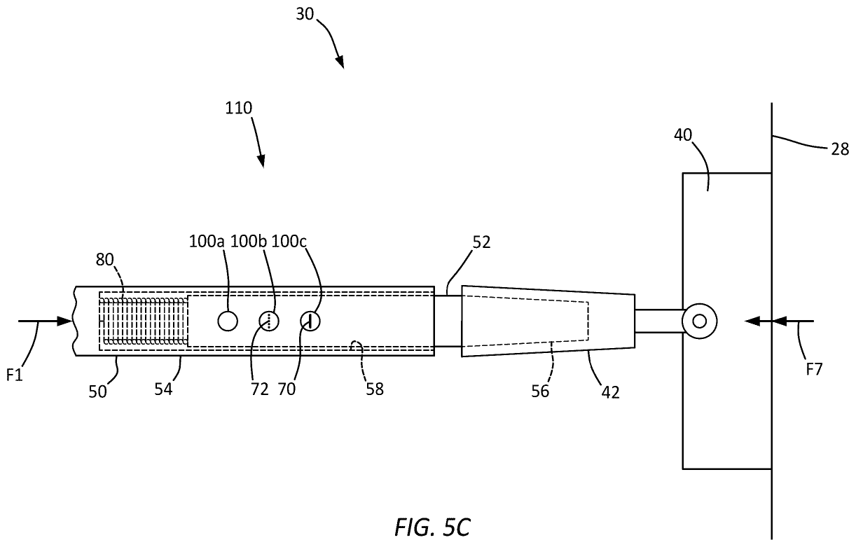

FIGS. 5A-5C are representative partial cross-sectional views of a tool system 30 in various positions of a telescoping handle during engagement of the tool 40 with a building surface 28, in accordance with certain embodiments. The handle 50 can include a coupling portion 52 that can be slidably coupled to a bore 58 of an operator portion 54 of the handle 50. A biasing device 80 can be positioned between an end of the bore 58 and an end of the coupling portion 52. As the force F1 is applied to the operator portion 54 (or stationary portion 54) of the handle 50, the coupling portion 52 (or telescopic portion 52) can be forced further into the bore 58 and the biasing device 80 can compress further and further as more force is applied. In a non-limiting embodiment, the biasing device 80 can include a spring, a resilient rubber, a compressible gas bag, a pneumatic or hydraulic cylinder, or combinations thereof.

The force indicators 100a-100c can be visual alignment features 70, 72, 74 that align or misalign with alignment guides 170, 172, 174. The alignment features 70, 72, 74 can be visible markings on the telescopic portion 52 that move with the telescopic portion 52. The alignment guides 170, 172, 174 can be voids in the telescopic portion 52 to allow one or more of the alignment features 70, 72, 74 to be seen through the alignment guides 170, 172, 174 as the telescopic portion 52 is moved relative to the stationary portion 54. As the force F1 increases, the telescopic portion 52 can retract into the bore 58 and compress the biasing device 80. The position of the alignment features 70, 72, 74 on the telescopic portion 52 can be configured such that when the force F1 is within a predetermined range, the alignment of one of more of the alignment features 70, 72, 74 with one or more of the alignment guides 170, 172, 174 can indicate to an operator that the force F1 being applied by the handle 50 is within the optimal range of forces for optimal performance of the operation on the surface 28 by the tool 40.

When the force F1 is “0” zero, then the biasing device 80 can be at its maximum extension within the bore 58 and the telescopic portion 52 can be at it maximum extension relative to the stationary portion 54. At this point, none of the alignment features 70, 72, 74 may be aligned with any of the alignment guides 170, 172, 174. However, as the force F1 is increased to a range of forces that are below the predetermined range, but approaching the predetermined range, then the alignment features 70, 72 can be aligned with alignment guides 172, 174, respectively.

The alignment feature 72 can be visually different from the other alignment features 70, 74, so it can indicate when the force F1 is within the predetermined range. In this example, the operator 60 knows that the alignment feature 72 should be aligned with the alignment guide 172, which can indicate that the force F1 is within the predetermined range. However, FIG. 5A indicates that the force F1 is not yet high enough to apply to desired force to the tool 40 for optimal performance. Therefore, the operator 60 can be encouraged to increase the force F1 to increase the engagement force F7 against the surface 28.

FIG. 5B shows that the force F1 has been increased to a point that the alignment feature 72 is aligned with the alignment guide 172, indicating that the force F1 is within the predetermined range of forces. The biasing device 80 is further compressed in the bore 58. The other alignment features 70, 74 are shown also aligned with the other alignment guides 170, 174. This alignment pattern can also be used to indicate that the force F1 is within the predetermined range of forces. However, the other alignment features 70, 74 can be merely used to provide addition guidance to the operator 60 to know if the force F1 is above or below the predetermined range.

FIG. 5C shows that the force F1 has been increased to a point that the alignment feature 72 is aligned with the alignment guide 170, indicating that the force F1 is above the predetermined range of forces and the biasing device 80 is further compressed in the bore 58. This can encourage the operator 60 to reduce the force F1 to again align the alignment feature 72 with the alignment guide 172. As the force F1 is reduced, the biasing device 80 can expand moving the telescopic portion 52 further out of the bore 58. This immediate feedback can help the operator 60 to more consistently apply the desired force to the handle 50.

This telescoping handle 50 with visual force indicators 100a, 10b, 100c can also allow various force ranges to be selected for different types of tools 40. Referring back to FIG. 5A, another group of alignment features 70′, 72′, 74′ are shown on the telescopic portion 52. In the current configuration, these alignment features are not in a position to be viewed through the alignment guides 170, 172, 174. These alignment features 70′, 72′, 74′ can be positioned at different axial locations along the telescopic portion 52, as shown, than the alignment features 70, 72, 74.

Being at different axial positions, these alignment features 70′, 72′, 74′ indicate a different range of forces for the force F1 than would be indicated by the alignment features 70, 72, 74. To select the alignment features 70′, 72′, 74′ instead of the alignment features 70, 72, 74, the stationary portion 54 can be rotated (arrows 90) relative to the telescopic portion 52 to position the alignment features 70′, 72′, 74′ to be circumferentially aligned with the alignment guides 170, 172, 174, so that when the force F1 is applied to the handle 50 with the second tool 40 engaged with the surface 28, then the alignment features 70′, 72′, 74′ can be used to axially align with the alignment guides 170, 172, 174 to indicate when the force F1 is inside or outside the predetermined range of forces for the desired operation using the second tool 40.

FIG. 6 is a functional block diagram of a force indicator system 110 of the tool system 30, in accordance with certain embodiments. The force indicator system 110 can include a controller 120 that can control generation of force indicators 100 (e.g., force indicators 100a-100c) based upon force measurements received from a force transducer 112 that can be disposed between the operator portion 54 and the coupling portion 52 of the handle 50 to detect and measure the force (e.g., force F1) applied to the tool 40 via the handle 50. A peripheral interface 136 can be used by the controller 120 to receive the force measurements from the force transducer 112 over a communication link 154.

The peripheral interface 136 can transfer the force measurements to one or more processors 132 to determine if the force measurements are inside or outside of a predetermined range. Each tool type can have a different range (even if only slightly different) of forces that are included in the predetermined range. Therefore, multiple types of tools can result in a plurality of predetermined ranges, with each of the predetermined ranges being associated with a particular tool type. The plurality of predetermined ranges can be stored in a force database 140 for later retrieval by the one or more processors 132 when the one or more processors 132 are determining if the first force F1 is inside or outside the particular predetermined range associated with the tool type.

A force selector 102 of the controller 120 can be used to determine the type of tool 40 being used and to communicate the tool type to the one or more processors 132, which can retrieve the associated predetermined range of forces for that tool type from the force database 140 for comparisons to the force measurements. A force measurement from the force transducer 112 can be an electrical signal that can be representative of the force F1 being applied to the tool 40. The force values of the force measurements and the force values in the predetermined ranges can be values of the electrical signal generated by the force transducer 112, which can be representative of actual forces applied without being actual force values with force units. The controller 120 can also generate different force indications or sequence of force indications or types of force indications based on the tool type that is selected.

In this case, the one or more processors 132 can compare these representative values from the force transducer with representative values of the predetermined range, without transforming the representative values to actual force values. However, it should be understood that the predetermined range of forces can be force values instead of representative values, and the one or more processors 132 can convert the signal values from the force transducer 112, which are representative of the applied force (e.g., millivolts), to a force value with force units (e.g., newton, pound, etc.) for comparison to the force values in the predetermined range of forces.

The one or more processors 132 can receive commands and data from a non-transitory instructions memory 134 that can cause the one or more processors 132 to execute a control program for determining when to activate or generate one or more indications using one or more force indicators 100 to alert an operator 60 as to an amount of force being applied to the tool 40 via the handle 50. The one or more processors 132 can receive the force measurements from the force transducer 112, compare them to the particular predetermined range depending on the tool type, and command one or more force indicators 100 to generate one or more indications to the operator.

The one or more processors 132 can control one or more force indicators 100 to generate one or more indications via a wired communication link 154, as well as using wireless communication (e.g., wireless signals 62, 66) to one or more force indicators 100 to control generation of the indications (e.g., via force indicator 100e on the tool 40).

The peripheral interface 136 can be used by the controller 120 to communicate with the remote control device 82, the HMI device 130, and the ID device 78 (e.g., via wireless signals 62, 64, 66, 68). The peripheral interface 136 can receive the tool type from the HMI device 130 (e.g., via operator input) or the ID device 78 (e.g., via scanning the ID device 78, such as a radio frequency ID device, on the tool 40). In a non-limiting embodiment, the HMI device 130 can be removably coupled to the controller 120 via a wired communication link 138 as representatively illustrated in FIG. 4.

The force indicator system 110 can be powered by an energy storage device 144 (e.g., a battery, a capacitor, etc.). The energy storage device 144 can receive and store energy provided by the charge controller 142, which can receive from a power connection 146. The power connection 146 can be removably connected to a power supply cable 150, which can supply power to the power connection 146 from a power supply 152. The power supply 152 can be utility power, such as from power connections in the building 10, or a portable power generator, or a portable energy storage system (such as a battery storage system). This allows the operator to recharge the energy storage device 144 as needed. However, it should be understood that the energy storage device 144 can also be replaced with a new energy storage device 144, without needing to charge the energy storage device 144.

As used herein, an “operator 60” refers to a human or a robot, as long as the human or robot can selectively grip and release the handle 50 of the tool system 30, and apply force to the tool 40 via the handle 50 when it is gripping the handle 50. The operator 60 can also provide inputs to the controller 120 via the HMI device, such as for selecting the tool type.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, “generally”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

### VARIOUS EMBODIMENTS

Embodiment 1. A system for indicating a force applied to a tool, the system comprising:
a tool configured to engage a surface of a building;
a handle configured to apply a first force to the tool; and
a force indicator configured to indicate a representation of the first force to an operator.
Embodiment 2. The system of embodiment 1, wherein the handle is removably coupled to the tool.
Embodiment 3. The system of embodiment 2, wherein the tool is configured to apply an engagement force to the surface based on the first force applied to the tool, and wherein a predetermined range of the first force provides a desired force range of the engagement force.
Embodiment 4. The system of embodiment 3, wherein the force indicator generates a first indication when the first force is within the predetermined range.
Embodiment 5. The system of embodiment 4, wherein the first indication is configured to indicate to the operator that the first force is within the predetermined range.
Embodiment 6. The system of embodiment 4, wherein force indicator generates a second indication when the first force is within a second range that is outside of the predetermined range, and wherein the second range is within a range of forces that approach the predetermined range.
Embodiment 7. The system of embodiment 6, wherein the force indicator comprises a first force indicator, and wherein the first indication and the second indication are produced by the first force indicator.
Embodiment 8. The system of embodiment 6, wherein the force indicator comprises a first force indicator and a second force indicator, and wherein the first indication is produced by the first force indicator and the second indication is produced by the second force indicator.
Embodiment 9. The system of embodiment 6, wherein the second indication is configured to indicate to the operator that the first force is outside of the predetermined range and within the range of forces that approach the predetermined range.
Embodiment 10. The system of embodiment 6, wherein force indicator generates a third indication when the first force is within a third range that is outside of the predetermined range, and wherein the third range is within a range of forces that exceed the predetermined range.
Embodiment 11. The system of embodiment 10, wherein the third indication is configured to indicate to the operator that the first force is outside of the predetermined range and within the range of forces that exceed the predetermined range.
Embodiment 12. The system of embodiment 11, wherein the force indicator comprises a first force indicator, and wherein the first indication, the second indication, and the third indication are produced by the first force indicator.
Embodiment 13. The system of embodiment 11, wherein the force indicator comprises a first force indicator, a second force indicator, and a third force indicator, and wherein the first indication is produced by the first force indicator, the second indication is produced by the second force indicator, and the third indication is produced by the third force indicator.
Embodiment 14. The system of embodiment 1, further comprising:
a sensor configured to detect the first force and transmit a signal to the force indicator, wherein the signal is representative of the first force.
Embodiment 15. The system of embodiment 14, wherein the force indicator comprises a controller, wherein the controller receives the signal from the sensor, and wherein the controller is configured to determine, based on the signal, if the first force is within a predetermined range and to generate a first indication if the first force is within the predetermined range.
Embodiment 16. The system of embodiment 15, wherein the first indication comprises one of a visual indication, an audio indication, a vibration indication, or a combination thereof, and wherein the first indication is configured to indicate to the operator that the first force is within the predetermined range.
Embodiment 17. The system of embodiment 16, wherein the visual indication, the audio indication, the vibration indication, or the combination thereof is produced by a smartphone, a smartwatch, a tablet, a wearable device, or a mobile device that receives a signal from the controller to produce the first indication or other indications.
Embodiment 18. The system of embodiment 16, wherein the visual indication, the audio indication, the vibration indication, or the combination thereof is produced by a force indicator in the tool.
Embodiment 19. The system of embodiment 16, wherein the visual indication comprises one or more light sources, and wherein the one or more light sources change in intensity to indicate that the first force is within the predetermined range.
Embodiment 20. The system of embodiment 19, wherein the one or more light sources are variable intensity light sources, and wherein the one or more light sources increase to a maximum intensity when the first force is within the predetermined range.
Embodiment 21. The system of embodiment 19, wherein the one or more light sources increase an intensity as a difference between the first force and the predetermined range is decreased, and wherein the one or more light sources decrease the intensity as a difference between the first force and the predetermined range is increased.
Embodiment 22. The system of embodiment 16, wherein the visual indication comprises one or more light sources, and wherein the one or more light sources change in color or frequency to indicate that the first force is within the predetermined range.
Embodiment 23. The system of embodiment 22, wherein the one or more light sources are colored light sources, and wherein the one or more light sources display a first color when the first force is within the predetermined range.
Embodiment 24. The system of embodiment 23, wherein the one or more light sources display a second color when the first force is below the predetermined range, and wherein the one or more light sources display a third color when the first force is above the predetermined range.
Embodiment 25. The system of embodiment 23, wherein one or more light sources display a second color when the first force is outside the predetermined range.
Embodiment 26. The system of embodiment 22, wherein the one or more light sources are variable frequency light sources, and wherein the one or more light sources display a first frequency of light when the first force is within the predetermined range.
Embodiment 27. The system of embodiment 26, wherein the one or more light sources emit a second frequency of light when the first force is below the predetermined range, and wherein the one or more light sources emit a third frequency of light when the first force is above the predetermined range.
Embodiment 28. The system of embodiment 22, wherein the one or more light sources comprise a first light source, a second light source, and a third light source, wherein the first light source emits a first color when the first force is within the predetermined range, wherein the second light source emits a second color when the first force is below the predetermined range, and wherein the third light source emits a third color when the first force is above the predetermined range.
Embodiment 29. The system of embodiment 28, wherein the first color, the second color, and the third color are the same color.
Embodiment 30. The system of embodiment 28, wherein the first color, the second color, and the third color are different colors.
Embodiment 31. The system of embodiment 28, wherein the first color is different than the second color and the third color.
Embodiment 32. The system of embodiment 16, wherein the audio indication comprises one or more audio sources that produce an audible signal, and wherein the one or more audio sources change an intensity of the audible signal to indicate that the first force is within the predetermined range.
Embodiment 33. The system of embodiment 32, wherein the one or more audio sources are variable intensity audio sources, and wherein the one or more audio sources increase to a maximum intensity of the audible signal when the first force is within the predetermined range.
Embodiment 34. The system of embodiment 32, wherein the one or more audio sources increase an intensity of the audible signal as a difference between the first force and the predetermined range is decreased, and wherein the one or more audio sources decrease the intensity of the audible signal as a difference between the first force and the predetermined range is increased.
Embodiment 35. The system of embodiment 16, wherein the audio indication comprises one or more audio sources that produce an audible signal, and wherein the one or more audio sources change a frequency of the audible signal to indicate that the first force is within the predetermined range.
Embodiment 36. The system of embodiment 35, wherein the one or more audio sources are variable frequency audio sources, and wherein the one or more audio sources increase to a maximum frequency of the audible signal when the first force is within the predetermined range.
Embodiment 37. The system of embodiment 35, wherein the one or more audio sources increase a frequency of the audible signal as a difference between the first force and the predetermined range is decreased, and wherein the one or more audio sources decrease the frequency of the audible signal as a difference between the first force and the predetermined range is increased.
Embodiment 38. The system of embodiment 35, wherein the one or more audio sources decrease a frequency of the audible signal as a difference between the first force and the predetermined range is decreased, and wherein the one or more audio sources increase the frequency of the audible signal as a difference between the first force and the predetermined range is increased.
Embodiment 39. The system of embodiment 16, wherein the vibration indication comprises one or more vibration sources that produce a vibration signal, and wherein the one or more vibration sources change an intensity of the vibration signal to indicate that the first force is within the predetermined range.
Embodiment 40. The system of embodiment 39, wherein the one or more vibration sources are variable intensity vibration sources, and wherein the one or more vibration sources increase to a maximum intensity of the vibration signal when the first force is within the predetermined range.
Embodiment 41. The system of embodiment 39, wherein the one or more vibration sources increase an intensity of the vibration signal as a difference between the first force and the predetermined range is decreased, and wherein the one or more vibration sources decrease the intensity of the vibration signal as a difference between the first force and the predetermined range is increased.
Embodiment 42. The system of embodiment 1, wherein the handle comprises:
   a telescopic portion slidably coupled to a stationary portion, wherein the tool is removably coupled to the telescopic portion;
   a biasing device that urges the telescopic portion in a first axial direction toward the tool, wherein application of the first force to the tool via the handle urges the telescopic portion in a second axial direction that is opposite the first axial direction;
   a first alignment feature on the telescopic portion; and
   a second alignment feature on the stationary portion.
Embodiment 43. The system of embodiment 42, wherein the first alignment feature is aligned with the second alignment feature when the first force is within a predetermined range.
Embodiment 44. The system of embodiment 42, wherein the first alignment feature does not align with the second alignment feature when the first force is outside of a predetermined range.
Embodiment 45. The system of embodiment 42, wherein the handle further comprises a third alignment feature on the stationary portion, and wherein the first alignment feature is aligned with the third alignment feature when the first force is outside a predetermined range and within a range of forces that are below the predetermined range.
Embodiment 46. The system of embodiment 45, wherein the handle further comprises a fourth alignment feature on the stationary portion, and wherein the first alignment feature is aligned with the fourth alignment feature when the first force is outside a predetermined range and within a range of forces that are above the predetermined range.
Embodiment 47. The system of embodiment 1, wherein the tool comprises multiple tools, and wherein the handle is configured to be removably coupled to any one of the multiple tools.
Embodiment 48. The system of embodiment 47, wherein a first tool of the multiple tools is configured to apply a first engagement force to a first surface based on the first force applied to the first tool, wherein a first predetermined range of the first force provides a first desired force range of the first engagement force, wherein a second tool of the multiple tools is configured to apply a second engagement force to a second surface based on the first force applied to the second tool, and wherein a second predetermined range of the first force provides a second desired force range of the second engagement force.
Embodiment 49. The system of embodiment 48, wherein the force indicator is configured to select between generation of a first indication when the first force is within the first predetermined range or generation of the first indication when the first force is within the second predetermined range.
Embodiment 50. The system of embodiment 48, wherein the force indicator is configured to select between generation of a first indication when the first force is within the first predetermined range or generation of the first indication when the first force is within the second predetermined range based on which of the first tool or the second tool is removably coupled to the handle.
Embodiment 51. The system of embodiment 47, wherein the force indicator comprises a force selector that selects a range of forces as a predetermined range of the first force for each of the multiple tools, and wherein the predetermined range varies for two or more of the multiple tools.
Embodiment 52. The system of embodiment 51, wherein the force selector selects the range of forces based on a unique identifier for each type of tool of the multiple tools.
Embodiment 53. The system of embodiment 52, wherein the type of tool comprises one of a corner roller, a tape/mud dispenser, a seam roller, a corner trowel, a flat trowel, a brick groove trowel, a sandpaper holder, orbital sander, a paint roller, a texture roller, a knife, a taping knife, a smoothing knife, a drywall knife, a utility knife, a sponge holder, a sanding sponge holder, a multitool, or a combination thereof.
Embodiment 54. The system of embodiment 52, wherein the unique identifier is detected when one of the multiple tools is removably coupled to the handle.
Embodiment 55. The system of embodiment 52, wherein the force indicator remotely scans an identification device in the tool to determine the unique identifier.
Embodiment 56. The system of embodiment 55, wherein the remote scan is initiated when any one of the multiple tools is removably coupled to the handle.
Embodiment 57. The system of embodiment 52, wherein the unique identifier is provided via a wireless communication link to a remote interface device, which scans an identification device in the tool to determine the unique identifier and transmits the unique identifier to the force indicator via the wireless communication link.
Embodiment 58. The system of embodiment 57, wherein the remote interface device comprises a smartphone, a smartwatch, a wearable device, a tablet, or a mobile device.
Embodiment 59. The system of embodiment 1, wherein the force indicator is disposed in one of the handle, the tool, or a combination thereof.
Embodiment 60. The system of embodiment 1, wherein the force indicator comprises multiple force indicators, wherein each of the multiple force indicators is representative of a predetermined range, wherein each of the predetermined ranges is a unique range of forces.
Embodiment 61. The system of embodiment 60, wherein each unique range of forces can overlap forces of one or more other unique ranges of forces.
Embodiment 62. The system of embodiment 60, wherein each of the multiple force indicators is configured to indicate a representation of the first force to the operator.
Embodiment 63. The system of embodiment 62, further comprising a selector that is configured to select which one of the multiple force indicators is enabled to indicate the representation of the first force to the operator.
Embodiment 64. The system of embodiment 63, wherein the selector receives a signal from a human machine interface (HMI) device which causes the selector to select one of the multiple force indicators.
Embodiment 65. The system of embodiment 64, wherein the HMI device comprises one of a button, a switch, a rotary selector, a voice recognition module, a touch screen, a smartphone, a smartwatch, a wearable device, a tablet, a mobile device, a keyboard, a mouse, a keypad, a joystick, a trackball, or a combination thereof.
Embodiment 66. The system of embodiment 63, wherein the selector receives a signal from an identification device of the tool when the tool is removably coupled to the handle, and wherein the selector selects one of the multiple force indicators based on a unique identifier contained in the signal.
Embodiment 67. The system of embodiment 66, wherein the handle is configured to be selectively gripped by the operator and receive a force from the operator that causes the handle to apply the first force to the tool.
Embodiment 68. The system of embodiment 67, wherein the operator is a robot that is configured to selectively grip and release the handle, and to apply a force to the handle when the robot grips the handle.
Embodiment 69. A method for indicating a force applied to a tool, the method comprising:
   receiving a first force at a first tool, wherein a handle is configured to apply the first force to the first tool and cause the first tool to engage a surface of a building; and
   indicating, via a force indicator, a first indication to an operator when the first force is within a first predetermined range.
Embodiment 70. The method of embodiment 69, further comprising:
   indicating, via the force indicator, a second indication to an operator when the first force is outside of the first predetermined range, and wherein the first force is within a range of forces that approach the first predetermined range.
Embodiment 71. The method of embodiment 70, further comprising:
   indicating, via the force indicator, a third indication to an operator when the first force is outside of the first predetermined range, and wherein the first force is within a range of forces that exceed the first predetermined range.
Embodiment 72. The method of embodiment 69, further comprising removably coupling the first tool to the handle.
Embodiment 73. The method of embodiment 72, further comprising:
   removing the first tool from the handle; and
   removably coupling a second tool to the handle.
Embodiment 74. The method of embodiment 73, further comprising:
   selecting a second predetermined range;
   receiving a second force at the second tool, wherein the handle is configured to apply the second force to the second tool and cause the second tool to engage a second surface; and
   indicating, via the force indicator, a second indication to an operator when the second force is within the second predetermined range.
Embodiment 75. The method of embodiment 74, wherein the selecting further comprises receiving, at a controller, a unique identifier from the second tool and selecting the second predetermined range based on the unique identifier.
Embodiment 76. The method of embodiment 74, wherein the selecting further comprises receiving, at a controller, a signal from a human machine interface (HMI) device and selecting the second predetermined range based on the signal.
Embodiment 77. The method of embodiment 76, wherein the HMI device comprises one of a button, a switch, a rotary selector, a voice recognition module, a touch screen, a smartphone, a smartwatch, a wearable device, a tablet, a mobile device, a keyboard, a mouse, a keypad, a joystick, a trackball, or a combination thereof.
Embodiment 78. The method of embodiment 74, wherein the second indication comprises one of a visual indication, an audio indication, a vibration indication, or a combination thereof, and wherein the second indication is configured to indicate to the operator that the second force is within the second predetermined range.
Embodiment 79. The method of embodiment 69, wherein the first indication comprises one of a visual indication, an audio indication, a vibration indication, or a combination thereof, and wherein the first indication is configured to indicate to the operator that the first force is within the first predetermined range.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

What is claimed is:

1. A system for indicating a force applied to a tool, the system comprising:
a tool configured to engage a surface of a building;
a handle configured to apply a first force to the tool; and
a force indicator configured to indicate a representation of the first force to an operator.

2. The system of claim 1, wherein the handle is removably coupled to the tool.

3. The system of claim 2, wherein the tool is configured to apply an engagement force to the surface based on the first force applied to the tool, and wherein a predetermined range of the first force provides a desired force range of the engagement force.

4. The system of claim 3, wherein the force indicator generates a first indication when the first force is within the predetermined range.

5. The system of claim 4, wherein the first indication is configured to indicate to the operator that the first force is within the predetermined range.

6. The system of claim 4, wherein the force indicator generates a second indication when the first force is within a second range that is outside of the predetermined range, and wherein the second range is within a range of forces that approach the predetermined range.

7. The system of claim 1, further comprising:
a sensor configured to detect the first force and transmit a signal to the force indicator, wherein the signal is representative of the first force.

8. The system of claim 7, wherein the force indicator comprises a controller, wherein the controller receives the signal from the sensor, and wherein the controller is configured to determine, based on the signal, if the first force is within a predetermined range and to generate a first indication if the first force is within the predetermined range.

9. The system of claim 8, wherein the first indication comprises one of a visual indication, an audio indication, a vibration indication, or a combination thereof, and wherein the first indication is configured to indicate to the operator that the first force is within the predetermined range.

10. The system of claim 1, wherein the handle comprises:
a telescopic portion slidably coupled to a stationary portion, wherein the tool is removably coupled to the telescopic portion;
a biasing device that urges the telescopic portion in a first axial direction toward the tool, wherein application of the first force to the tool via the handle urges the telescopic portion in a second axial direction that is opposite the first axial direction;
a first alignment feature on the telescopic portion; and
a second alignment feature on the stationary portion, wherein the first alignment feature is aligned with the second alignment feature when the first force is within a predetermined range, and wherein the first alignment feature does not align with the second alignment feature when the first force is outside of a predetermined range.

11. The system of claim 1, wherein the tool comprises multiple tools, wherein the handle is configured to be removably coupled to any one of the multiple tools, wherein a first tool of the multiple tools is configured to apply a first engagement force to a first surface based on the first force applied to the first tool, wherein a first predetermined range of the first force provides a first desired force range of the first engagement force, wherein a second tool of the multiple tools is configured to apply a second engagement force to a second surface based on the first force applied to the second tool, and wherein a second predetermined range of the first force provides a second desired force range of the second engagement force.

12. The system of claim 1, wherein the tool comprises multiple tools, wherein the handle is configured to be removably coupled to any one of the multiple tools, wherein the force indicator comprises a force selector that selects a range of forces as a predetermined range of the first force for each of the multiple tools, and wherein the predetermined range varies for two or more of the multiple tools.

13. The system of claim 1, wherein the force indicator comprises multiple force indicators, wherein each of the multiple force indicators is representative of a predetermined range, wherein each of the predetermined ranges is a unique range of forces, and wherein each unique range of forces can overlap forces of another unique range of forces, and wherein each of the multiple force indicators is configured to indicate a representation of the first force to the operator.

14. A method for indicating a force applied to a tool, the method comprising:
receiving a first force at a first tool, wherein a handle is configured to apply the first force to the first tool and cause the first tool to engage a surface of a building; and
indicating, via a force indicator, a first indication to an operator when the first force is within a first predetermined range.

15. The method of claim 14, further comprising:
indicating, via the force indicator, a second indication to the operator when the first force is outside of the first predetermined range, wherein the first force is within a range of forces that approach the first predetermined range; and
indicating, via the force indicator, a third indication to the operator when the first force is outside of the first predetermined range, wherein the first force is within a range of forces that exceed the first predetermined range.

16. The method of claim 14, further comprising removably coupling the first tool to the handle.

17. The method of claim 16, further comprising:
removing the first tool from the handle; and
removably coupling a second tool to the handle.

18. The method of claim 17, further comprising:
selecting a second predetermined range;
receiving a second force at the second tool, wherein the handle is configured to apply the second force to the second tool and cause the second tool to engage a second surface; and
indicating, via the force indicator, a second indication to an operator when the second force is within the second predetermined range.

19. The method of claim 18, wherein the selecting further comprises:
receiving, at a controller, a unique identifier from the second tool and selecting the second predetermined range based on the unique identifier; or
receiving, at the controller, a signal from a human machine interface (HMI) device and selecting the second predetermined range based on the signal.

20. The method of claim 14, wherein the first indication comprises one of a visual indication, an audio indication, a vibration indication, or a combination thereof, and wherein the first indication is configured to indicate to the operator that the first force is within the first predetermined range.
